(19) United States
(12) Patent Application Publication
(10) Pub. No.: US 2021/0101528 A1
(43) Pub. Date: Apr. 8, 2021

(54) Vehicle Alert System and Method

(71) Applicant: Erin Gomez, Las Vegas, NV (US)

(72) Inventors: Erin Gomez, Las Vegas, NV (US); Ralph Gomez, Las Vegas, NV (US)

(73) Assignee: Ralph Ralph, Las Vegas, NV (US)

(21) Appl. No.: 17/000,207

(22) Filed: Aug. 21, 2020

Related U.S. Application Data
(60) Provisional application No. 62/912,507, filed on Oct. 8, 2019.

(51) Int. Cl. B60Q 9/00; G08B 21/02; B60R 16/03; G01G 19/44; G01S 19/42

(52) U.S. Cl. CPC B60Q 9/00; G08B 21/0277; G01S 19/42; B60R 16/03; G01G 19/44; G08B 21/0269

(57) ABSTRACT

A vehicle alert system and method are provided. The vehicle alert system includes a housing in the shape of a pad designed to fit between a vehicle seat and a car seat. A sensor is disposed within the housing that can detect weight disposed on a top surface of the housing. A GPS transceiver and wireless transmitter are disposed within the housing for locating a position of the housing in use and wirelessly communicating information detected to an electronic device. A USB port is retractably connected to the housing, wherein the USB port can connect to an adaptor for supplying power to the housing. The electronic device includes a graphical user interface (GUI) and a logic capable of receiving and displaying information from the wireless transmitter. The logic is configured to send a first reminder to the electronic device after a first predetermined amount of time has passed without detecting a weight decrease. If the weight decrease is not detected within a second predetermined amount of time, the system will emit a second reminder in the form of an audible and physical alert. The second reminder will not deactivate until the weight decrease is detected.

### BACKGROUND OF THE INVENTION

The present invention relates to a vehicle alert system and method. The present invention provides a system comprising a housing designed to fit between a vehicle seat and a car seat for detecting and alerting a user when a child is left unattended in a vehicle.

Vehicles become overwhelmingly hot when sitting in the sun during hot or warm days. In many situations, the interior temperature can be 50 percent hotter than the temperature exterior to the vehicle. Further, after a vehicle has stopped running, there exists a risk that the interior temperature will rapidly increase. A vehicle's interior temperature can rise as much as 35 degrees Fahrenheit in 20 minutes. Unfortunately, it is easy for a driver exiting the vehicle to forget how hot the vehicle will become because he or she is no longer exposed to the interior temperate for a prolonged period of time.

However, a child remaining within the vehicle can suffer damaging and life-threatening consequences if left unattended in a hot vehicle. Exposure to 100 degrees Fahrenheit plus temperature can be fatal for a small child. The heat rapidly overwhelms the ability of a small child to regulate his or her own temperature, which can result in heat stroke and death.

There have been attempts to solve this problem, however none of the known devices provide a weight-sensing housing comprising a non-skid coating, internal weight sensors, power cord, Bluetooth®, and GPS technology in communication with a mobile application which is configured to provide audible and physical notifications if a child is left unattended in a vehicle in functional combination.

In light of the devices disclosed in the known art, it is submitted that the present invention substantially diverges in design elements and methods from the known art and consequently it is clear that there is a need in the art for an improvement for a vehicle alert system and method. In this regard the instant invention substantially fulfills these needs.

### SUMMARY OF THE INVENTION

In view of the foregoing disadvantages inherent in the known types of vehicle alert systems and methods now present in the known art, the present invention provides a new vehicle alert system and method wherein the same can be utilized for receiving detailed item information and allowing a user to quickly locate those items in a store.

It is an objective of the present invention to provide a vehicle alert system comprising a housing configured to fit between a vehicle seat and a car seat. A sensor is disposed within the housing that can detect weight disposed on a top surface of the housing. A GPS transceiver and wireless transmitter are disposed within the housing for locating a position of the housing in use and wirelessly communicating information detected to an electronic device. A USB port is retractably connected to the housing, wherein the USB port is configured to connect to an adaptor for supplying power to the housing. In some embodiments, the adaptor is a 12-volt auxiliary power adapter and in other embodiments, the adaptor is a cube-and-prong power adapter configured to connect to USB port.

It is another objective of the present invention to provide a vehicle alert system having an electronic device includes a graphical user interface (GUI) and a logic capable of receiving and displaying information from the wireless transmitter. The logic is configured to send a first reminder to the electronic device after a first predetermined amount of time has passed without detecting a weight decrease. If the weight decrease is not detected within a second predetermined amount of time, the system will emit a second reminder in the form of an audible and physical alert. The second reminder will not deactivate until the weight decrease is detected.

It is therefore an object of the present invention to provide a new and improved new vehicle alert system and method that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment. Additionally, “system” and “method” may be used interchangeably and refer to the present invention.

FIG. 1 shows a perspective view of an embodiment of the vehicle alert system.

FIG. 2 shows perspective views of an embodiment of the vehicle alert system positioned on a rear vehicle seat and beneath a car seat.

FIG. 3 shows a perspective view of the housing of an embodiment of the vehicle alert system.

FIG. 4 shows a side perspective view of the housing of an embodiment of the vehicle alert system.

FIG. 5 shows a pair of perspective view of the USB cord of an embodiment of the vehicle alert system, wherein the cord is shown in a retracted position and an extended position, respectively.

FIG. 6 shows a perspective view of an embodiment of the vehicle alert system connected to a vehicle.

FIG. 7 shows a perspective view of a first reminder on the GUI of an embodiment of the vehicle alert system.

FIG. 8 shows a perspective view of a second reminder of the GUI of an embodiment of the vehicle alert system.

### DETAILED DESCRIPTION OF THE INVENTION

For the purposes of presenting a brief and clear description of the present invention, the preferred embodiment will be discussed as used for receiving detailed item information and allowing a user to quickly locate those items in a store.

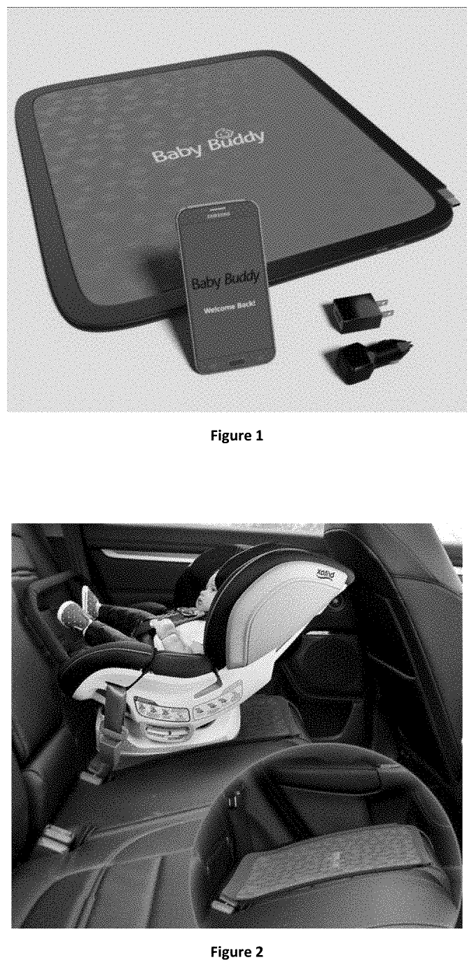

Referring now to FIGS. 1 and 2, there is shown a perspective view of an embodiment of the vehicle alert system and perspective views of an embodiment of the vehicle alert system positioned on a rear vehicle seat and beneath a car seat, respectively. The vehicle alert system is configured to detect if a child is left in a vehicle once the vehicle is turned off. The system comprises a housing designed to fit between a vehicle seat and a car seat, wherein the housing wirelessly connects to a software application on an electronic device in order to remind and alert a user and authorities if the child has remained in the vehicle after a predetermined amount of time. The housing is portable and can be easily transferred between vehicles so a user, along with multiple secondary users, can operate the system. A user is defined as a driver of a vehicle and a secondary user is defined as an alternate caregiver interested in the wellbeing of the child, such as, but not limited to parents, babysitters, childcare facility employees.

In alternate embodiments, the system is configured to be used with strollers and other portable carriers. Some embodiments contemplate utilizing the system in conjunction with a portable crib or playpen. In other embodiments, the system is used with wheelchairs and other adult mobility aids to monitor caregiver oversight of patients, the disabled and/or the elderly or for use in pet carriers.

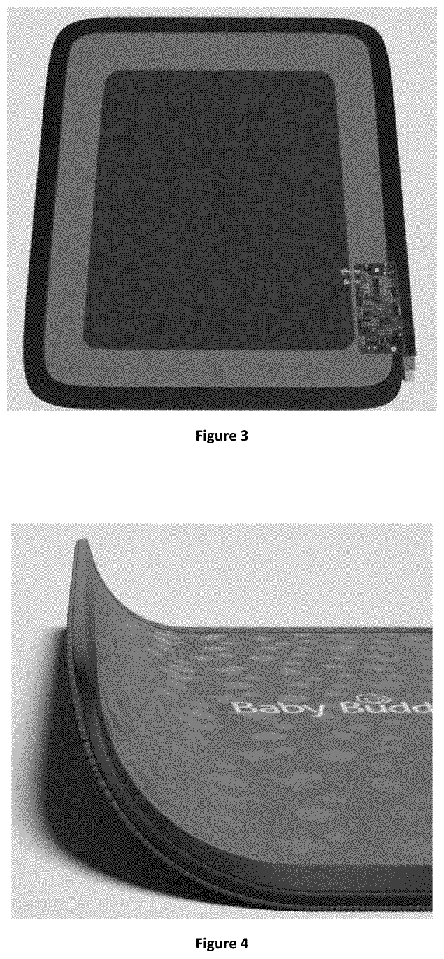

Referring now to FIGS. 3 and 4, there is shown a perspective view and a side perspective view of the housing of an embodiment of the vehicle alert system, respectively. In the illustrated embodiment, the housing is a flat, planar pad configured to house at least one sensor, a GPS transmitter, and a wireless transmitter. The housing is configured to rest flat on a vehicle seat and support a car seat thereon. In the illustrated embodiment, the housing is composed of a pliable pad, measuring approximately eighteen inches in length by fourteen inches in width by one-half inch in depth (18″×14″×½″). However, in alternate embodiments, the housing is composed of any suitable material and shape configured to stably and securely support and detect a weight of the car seat. A non-slip layer is position on a bottom side thereof to prevent the housing from moving while in use. The non-slip layer is configured directly contact a vehicle seat. In the illustrated embodiment, the bottom side of the housing is lined with a textured synthetic rubber material.

The sensor is disposed within the housing that can detect weight disposed on a top surface of the housing. In some embodiments, more than one sensor is disposed within the housing to detect weight along various points of the top surface. The GPS transceiver is configured to transmit a location of the housing to the electronic device when the system is in use. In this way, local authorities or a secondary user can immediately locate the child in the vehicle. In the illustrated embodiment, the wireless transmitter is Bluetooth and is configured to transmit information detected by the sensor to the electronic device.

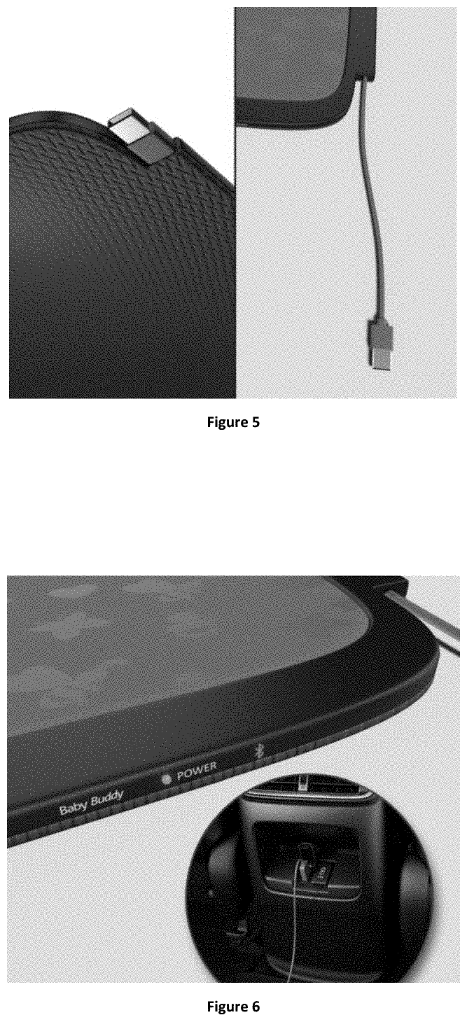

Referring now to FIGS. 5 and 6, there is shown a pair of perspective view of the USB cord of an embodiment of the vehicle alert system, wherein the cord is shown in a retracted position and an extended position and a perspective view of an embodiment of the vehicle alert system connected to a vehicle, respectively. A USB port is retractably connected to the housing, wherein the USB port can connect to an adaptor for supplying power to the housing. In the illustrated embodiment, a cutout is disposed along a perimeter of the housing for storing the USB port therein when in the retracted position. A cord connected to the USB port is configured to retract within the housing.

The USB port, GPS transmitter, Bluetooth, and sensor are all operably connected via an electric circuit in order to receive power for operation. In some embodiments, the vehicle alert system comprises an adaptor in order to connect the USB port to a vehicle's power supply. In the illustrated embodiment, the system comprises both a 12-volt auxiliary power adapter and a cube-and-prong power adapter configured to connect to USB port. In this way, a user may connect and supply power to the housing through various ports located in a vehicle.

In the illustrated embodiment, a power panel is disposed on a sidewall of the housing to indicate to a user if the system is active or turned on. The power panel includes a power light and a Bluetooth light that are configured to illuminate when power is being supplied thereto. If no power is being supplied, the power light and the Bluetooth light will remain unilluminated.

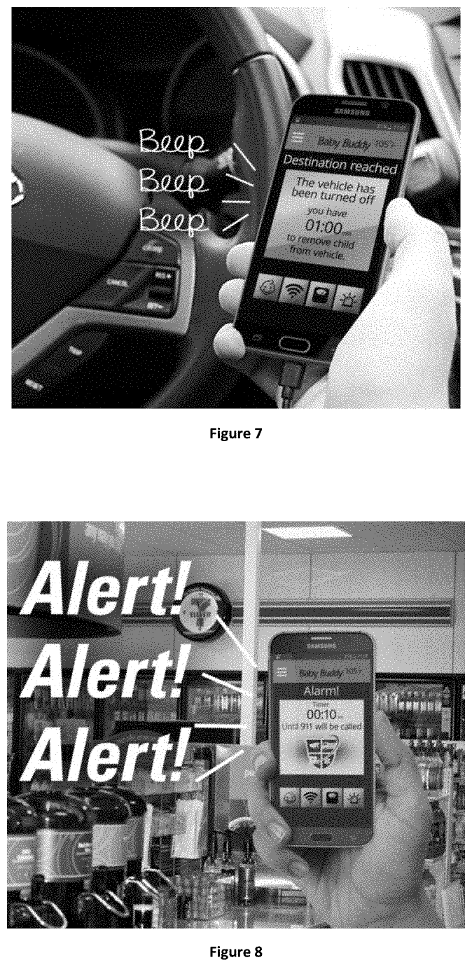

Referring now to FIGS. 7 and 8, there is shown a perspective view of a first reminder and a second reminder/alert on the GUI of an embodiment of the vehicle alert system, respectively. In some embodiments, the vehicle alert system includes an electronic device, such as a computer, smartphone, or other mobile electronic device, having a graphical user interface (GUI) and a logic capable of receiving and displaying information from the wireless and GPS transmitter. The logic is configured to receive information from the sensor and determine if a weight detected is greater than a baseline weight of the car seat. If the weight difference detected by the logic is above a threshold weight, then a first reminder is displayed on the GUI of the electronic device after a first predetermined amount of time has passed. The first reminder will terminate once the weight detected is below the threshold weight, indicating that the child has been removed from the car seat. In the illustrated embodiment, the first reminder will only be displayed once the vehicle has been turned off. If the weight decrease is not detected within a second predetermined amount of time, the system will emit a second reminder/alert in the form of an audible and physical alert. The second reminder will not deactivate until the weight decrease is detected. The second predetermined amount of time is longer than the first predetermined amount of time.

The audible or physical alert is, but not limited to, a sound emitting from a speaker of the electronic device, a vibration emitted from the electronic device, text scrolling on the display of the electronic device, text displayed on the housing, text alerts being sent to mobile devices in the proximity of the housing in order to alert bystanders of possible danger, and activating the vehicle's alarm system to alert further alert the user and other people nearby of possible child endangerment.

In some embodiments, the alert cannot be ceased, modified or silenced until the child is removed from the vehicle. As a final warning, the system displays a countdown on the GUI that indicates when emergency services, and potentially other secondary users, will be notified that the car seat using child is endangered and provided the child's location.

In operation, the user positions the housing upon a rear seat of the vehicle and plugs the housing into a power receptacle of the hosting vehicle via the USB and adaptor. Next, the housing receives the child seat thereupon. Once the vehicle is started, a signal is sent to the software application or logic to store the baseline weight, which is the weight of the car seat without a child. The child is placed within the car seat and the weight will automatically be sent to the application and thereby notifying the user or secondary user that a child is present in the car seat. Once the vehicle is turned off the first reminder will be sent to the user, followed by the second reminder/alert if necessary.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A vehicle alert system and method, comprising:
a housing configured to rest beneath of a car seat, wherein the housing is flat;
a sensor disposed within the housing configured to detect weight;
a GPS transceiver disposed within the housing;
a wireless transmitter disposed in the housing, such as Bluetooth®;
a USB port disposed on an end of a power cord retractably disposed within the housing, wherein the USB port is positioned exterior to the housing;
a power adapter configured to connect to the USB port;
a second power course, such as a cube-and-prong power adapter configured to connect to the USB port;
wherein the GPS transceiver, wireless transmitter, are operably connected to one another;
a portable electronic device having a logic configured to:
receive and display a first reminder after a first predetermined amount of time;
receive and display a second reminder/alert after a second predetermined amount of time,
wherein the second reminder/alert is both an audible and physical alert;
wherein the second reminder/alert will not deactivate until a weight decrease is detected and received.
